(19) United States
(12) Patent Application Publication
(10) Pub. No.: US 2023/0297849 A1
(43) Pub. Date: Sep. 21, 2023

(54) FEDERATED LEARNING METHOD AND DEVICE, AND STORAGE MEDIUM

(71) Applicant: TENCENT TECHNOLOGY (SHENZHEN) COMPANY LIMITED, Shenzhen (CN)

(72) Inventors: Yong CHENG, Shenzhen (CN); Jie JIANG, Shenzhen (CN); Kang WEI, Shenzhen (CN); Yuhong LIU, Shenzhen (CN); Peng CHEN, Shenzhen (CN); Yangyu TAO, Shenzhen (CN)

(21) Appl. No.: 18/323,014

(22) Filed: May 24, 2023

Related U.S. Application Data
(63) Continuation of application No. PCT/CN2022/120080, filed on Sep. 21, 2022.

(30) Foreign Application Priority Data
Oct. 27, 2021 (CN) 202111264081.2

(51) Int. Cl. G06N 5/01

(52) U.S. Cl. CPC G06N 5/01

(57) ABSTRACT

A federated learning method includes: determining at least one candidate feature from data features corresponding to a training data-set, the candidate feature corresponding to at least two decision trends in a decision tree model; obtaining n first decision tree models by taking the at least one candidate feature as a model construction foundation, value of n corresponding to number of the at least one candidate feature; determining at least one second decision tree model from the n first decision tree models based on prediction results of the n first decision tree models on training data in the training data-set; and transmitting the second decision tree model to a second computing device, the second computing device being configured to fuse at least two decision tree models that comprise the second decision tree model to obtain a federated learning model.

### CROSS-REFERENCES TO RELATED APPLICATIONS

This application is a continuation application of PCT Patent Application No. PCT/CN2022/120080, filed on Sep. 21, 2022, which claims priority to Chinese Patent Application No. 202111264081.2, filed on Oct. 27, 2021, all of which are incorporated by reference in their entirety.

### FIELD OF THE TECHNOLOGY

Embodiments of the present disclosure relate to the technical field of computers, and in particular, to a federated learning method, apparatus and device, and a storage medium and a product.

### BACKGROUND OF THE DISCLOSURE

With the development of computer technologies, federated learning has become a hot topic. The federated learning trains the machine learning and deep learning models through multi-party cooperation, and solves the problems of data islands while protecting the user's privacy and data security. The federated learning includes horizontal federated learning, vertical federated learning, and federated transfer learning.

For the horizontal federated learning, encrypted model parameters are usually transmitted by a participant to a federated server. The federated server adjusts the model parameters and transmits the model parameters to the participant. The participant continues to adjust the model parameters based on local data and then transmits the model parameters to the federated server again. The federated server and the participant iterate the above adjustment process until the model parameters reach the standard, and stop the adjustment process to obtain a federated training model, thereby meeting the requirements of protecting the data security and privacy through the federated training model.

However, because the process of iteratively adjusting the model parameters by the federated server and the participant consumes a large amount of communication overhead, the federated server cannot effectively construct the federated learning model with the participant while ensuring the security. As such, it is impossible to protect the data privacy and reduce the communication consumption at the same time.

### SUMMARY

According to an aspect, a federated learning method is provided, and performed by a first computing device. The method includes: determining at least one candidate feature from data features corresponding to a training data-set, the candidate feature corresponding to at least two decision trends in a decision tree model; obtaining n first decision tree models by taking the at least one candidate feature as a model construction foundation, value of n corresponding to number of the at least one candidate feature; determining at least one second decision tree model from the n first decision tree models based on prediction results of the n first decision tree models on training data in the training data-set; and transmitting the second decision tree model to a second computing device, the second computing device being configured to fuse at least two decision tree models that comprise the second decision tree model to obtain a federated learning model.

According to another aspect, a computer device is provided and includes a processor and a memory, the memory storing at least one instruction, at least one program, a code set or an instruction set, and the at least one instruction, the at least one program, the code set or the instruction set being loaded and executed by the processor to implement a federated learning method. The method includes: determining at least one candidate feature from data features corresponding to a training data-set, the candidate feature corresponding to at least two decision trends in a decision tree model; obtaining n first decision tree models by taking the at least one candidate feature as a model construction foundation, value of n corresponding to number of the at least one candidate feature; determining at least one second decision tree model from the n first decision tree models based on prediction results of the n first decision tree models on training data in the training data-set; and transmitting the second decision tree model to a second computing device, the second computing device being configured to fuse at least two decision tree models that comprise the second decision tree model to obtain a federated learning model.

According to another aspect, a non-transitory computer-readable storage medium is provided for storing at least one instruction, at least one program, a code set or an instruction set, and the at least one instruction, the at least one program, the code set or the instruction set being loaded and executed by a processor to implement a federated learning method. The method includes: determining at least one candidate feature from data features corresponding to a training data-set, the candidate feature corresponding to at least two decision trends in a decision tree model; obtaining n first decision tree models by taking the at least one candidate feature as a model construction foundation, value of n corresponding to number of the at least one candidate feature; determining at least one second decision tree model from the n first decision tree models based on prediction results of the n first decision tree models on training data in the training data-set; and transmitting the second decision tree model to a second computing device, the second computing device being configured to fuse at least two decision tree models that comprise the second decision tree model to obtain a federated learning model.

The technical solutions provided by the embodiments of the present disclosure have at least the following beneficial effects.

At least one candidate feature is determined from the data features corresponding to the local training data-set, and the n first decision tree models are constructed according to the candidate feature and the decision trends corresponding to the candidate feature; in order to make the first decision tree model more efficient in model prediction, at least one second decision tree model is selected from the n first decision tree models based on the prediction results of the n first decision tree models for the training data in the training data-set; the second decision tree model is transmitted to the second computing device; at least two decision tree models are fused by the second computing device to obtain the federated learning model; the first computing device obtains the second decision tree model based on the local training data, and there is no risk of privacy leakage; and at the same time, the first computing device transmits the second decision tree model to the second computing device for one time, and it is unnecessary to transmit the second decision tree model between the first computing device and the second computing device for multiple times, so that the consumption of excessive communication overhead is avoided, and the federated learning model is more convenient to construct.

### BRIEF DESCRIPTION OF THE DRAWINGS

FIG. 1 is a schematic diagram of a decision tree model provided by an exemplary embodiment of the present disclosure.

FIG. 2 is a schematic diagram of a decision tree model provided by another exemplary embodiment of the present disclosure.

FIG. 3 is a flowchart of a federated learning method provided by an exemplary embodiment of the present disclosure.

FIG. 4 is a flowchart of a federated learning method provided by another exemplary embodiment of the present disclosure.

FIG. 5 is a schematic diagram of a decision tree model provided by another exemplary embodiment of the present disclosure.

FIG. 6 is a flowchart of a federated learning method provided by another exemplary embodiment of the present disclosure.

FIG. 7 is a flowchart of a federated learning method provided by another exemplary embodiment of the present disclosure.

FIG. 8 is a flowchart of a federated learning system provided by an exemplary embodiment of the present disclosure.

FIG. 9 is a flowchart of a federated learning method provided by another exemplary embodiment of the present disclosure.

FIG. 10 is a process schematic diagram of a federated learning method provided by an exemplary embodiment of the present disclosure.

FIG. 11 is a process schematic diagram of a federated learning method provided by another exemplary embodiment of the present disclosure.

FIG. 12 is a process schematic diagram of a federated learning method provided by another exemplary embodiment of the present disclosure.

FIG. 13 is a structural block diagram of a federated learning apparatus provided by an exemplary embodiment of the present disclosure.

FIG. 14 is a structural block diagram of a federated learning apparatus provided by an exemplary embodiment of the present disclosure.

FIG. 15 is a structural block diagram of a federated learning apparatus provided by an exemplary embodiment of the present disclosure.

FIG. 16 is a structural block diagram of a server provided by an exemplary embodiment of the present disclosure.

### DESCRIPTION OF EMBODIMENTS

Embodiments of the present disclosure relate to a federated learning method, apparatus and device, and a storage medium and a product, which can reduce communication consumption under a condition of protecting the data privacy.

First, terms involved in the embodiments of the present disclosure are briefly introduced.

Differential privacy: a key concept related to the differential privacy is adjacent data-sets. Supposing that two data-sets x and x′ are given, if the two data-sets have and only have one different data, the two data-sets can be referred to as the adjacent data-sets. For a random algorithm [symbol] , if two outputs obtained by the random algorithm acting on the two adjacent data-sets, for example, two machine learning models are obtained by training respectively, and it is difficult to distinguish which data-set the output is from, the random algorithm [symbol] is considered to meet requirements of differential privacy. Expressed in formula, the differential privacy ε is defined as shown in formula I:

Pr( [symbol] (x)=o)≤e^{ε}Pr( [symbol] (x′)=o),∀o Formula I:

where o indicates the output, and ε indicates a privacy loss measure. The meaning of the formula is: for any adjacent data-sets, the probability of obtaining a specific output parameter by training is almost the same. Therefore, it is difficult for an observer to notice small changes of the data-set by observing the output parameter, and it is impossible to deduce a specific training data by observing the output parameter. A purpose of protecting the data privacy is achieved by using this method.

Federated learning: federated learning, also known as collaborative learning, can realize “availability but invisibility” of the data when the user privacy and data security are protected, that is, training tasks of the machine learning model are completed by multi-party collaboration; and furthermore, an inference service of the machine learning model can also be provided.

Different from the traditional centralized machine learning, in a federated learning process, two or more participants are collaborated to train one or more machine learning models. Based on distribution features of data, the federated learning may be classified into horizontal federated learning, vertical federated learning, and federated transfer learning. The horizontal federated learning, also known as sample-based federated learning, is applicable to cases where sample sets share the same feature space but are different in sample space; the vertical federated learning, also known as feature-based federated learning, is applicable to cases where the sample sets share the same sample space but are different in feature space; and the federated transfer learning is applicable to cases where sample sets are different not only in sample space but also in feature space.

With the research and progress of artificial intelligence technologies, the artificial intelligence technologies are researched and applied in various fields, such as conventional smart homes, smart wearable devices, virtual assistants, smart speakers, intelligent marketing, driver-less technology, automatic pilot, unmanned aerial vehicles, robots, intelligent medical care, intelligent customer service, Internet of vehicles, autonomous driving, smart transportation, and the like. It is believed that with the development of technologies, the artificial intelligence technologies will be used in more fields, and play an increasingly important role.

For the horizontal federated learning, encrypted model parameters are usually transmitted by a participant to a federated server. The federated server adjusts the model parameters and then transmits the model parameters to the participant. The participant continues to adjust the model parameters based on local data and then transmits the model parameters to the federated server again. The federated server and the participant iterate the above adjustment process until the model parameters reach the standard, and stop the adjustment process to obtain a federated training model, thereby meeting the requirement of protecting the data security and privacy through the federated training model. However, in the above process, because the process of iteratively adjusting the model parameters by the federated server and the participant consumes a large amount of communication overhead, the federated server cannot effectively construct the federated learning model with the participant while ensuring the security, and it is impossible to protect the data privacy and reduce the communication consumption at the same time.

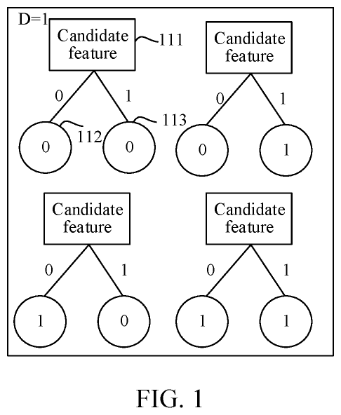

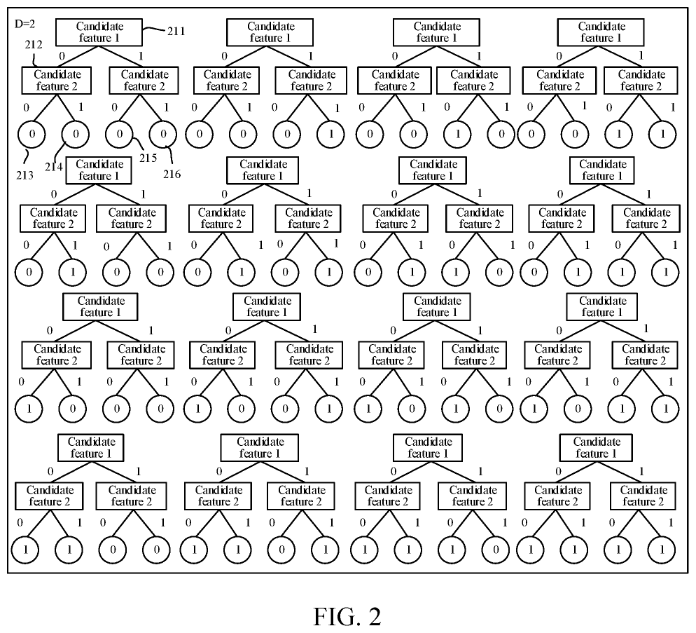

The decision tree model constructed in the embodiments of the present disclosure is described. The federated learning method provided by the embodiments of the present disclosure belongs to the horizontal federated learning method. The horizontal federated learning is applied to various computing devices of the federated learning. Sample data of the computing devices is same in feature space, but different in sample space. A core thought of the horizontal federated learning is to allow each first computing device to use local own training data to train a model, and then the models trained by a plurality of first computing devices are fused by a second computing device. Schematically, referring to FIG. 1 and FIG. 2, the decision tree model includes candidate features (including a candidate feature 111, a candidate feature 211, and a candidate feature 212), decision trends (0 and 1 among the candidate features and between the candidate feature and a leaf node in the drawings) corresponding to the candidate feature, and leaf nodes (that cannot be divided).

Schematically, D is used as the number of selected candidate features. After determining the candidate feature and the decision trends corresponding to the candidate feature, n decision tree models may be constructed by assigning values to the leaf nodes. A relationship between n and D is shown in formula II.

n=2²^{^{D}} Formula II:

Schematically, as shown in FIG. 1, when D=1, it indicates that one candidate feature 111 is selected. The candidate feature 111 has two leaf nodes (the leaf node 112 and the leaf node 113) corresponding to the candidate feature. The leaf nodes are assigned with values according to a binary classification standard. For example, “0 and 1” are assigned to the leaf node, that is, two values 0 or 1 are assigned to the leaf node 112 and the leaf node 113 to obtain four corresponding decision tree models in FIG. 1.

Similarly, as shown in FIG. 2, when D=2, it indicates that two candidate features are selected. An associated node having an association relationship with the candidate feature 211 is the candidate feature 212. The candidate feature 212 correspondingly generates four leaf nodes in different decision trends, i.e., the leaf node 213, the leaf node 214, the leaf node 215, and the leaf node 216. The leaf nodes are assigned with values according to the binary classification standard. For example, the values “0 and 1” are assigned to the leaf nodes, that is, two values 0 and 1 are provided for the leaf node 213, the leaf node 214, the leaf node 215, and the leaf node 216 to obtain sixteen corresponding decision tree models in FIG. 2.

In combination with the above introduction of terms and application scenarios, the federated learning method provided by the present disclosure is described. The method can be applied to a terminal or a server, and can also be implemented collectively by the terminal and server. The terminal may be a mobile terminal such as a mobile phone, a tablet computer, a portable laptop, and the like, and may also be a desktop computer, etc. The server may be an independent physical server, or a server cluster or distributive system composed of a plurality of physical servers, or a cloud server providing cloud services, cloud databases, cloud computation, cloud functions, cloud storage, network services, cloud communication, middle-ware services, domain name services, security services, content delivery network (CDN), and basic cloud computing services such as big data, artificial intelligent platforms and the like.

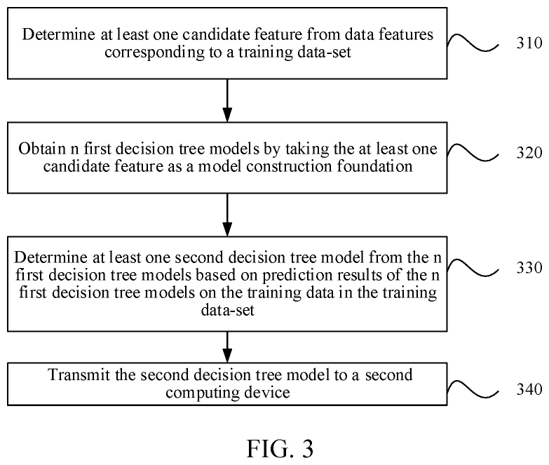

By taking the method applied to a first computing device as an example, as shown in FIG. 3, the method includes the following steps:

Step 310: Determine at least one candidate feature from data features corresponding to a training data-set.

The first computing device stores the training data-set which includes at least one piece of training data. Schematically, when the first computing device is a terminal, the training data includes at least one piece of training data stored in the terminal, for example: the terminal is provided with a financial application program, the financial application program stores age training data, gender training data, etc., wherein the age training data indicates the age-related data filled in by a user; and the gender training data indicates the gender-related data filled in by the user.

For a piece of training data, there is a data feature corresponding to the training data. Schematically, the training data is a piece of text data. Text content is “A is a watermelon with clear grains and curly roots”. For the text, the corresponding data feature is determined first. For example, the data feature includes: grains and roots.

In an exemplary embodiment, the candidate feature is obtained from the data features corresponding to the training data-set by the following several methods.

1. At least one data feature is randomly selected from the data features corresponding to the training data-set as the candidate feature.

Schematically, the candidate feature is randomly selected from the data features, that is, the candidate feature is selected from the data features at equal probability. For example: after obtaining information that the data feature of the above text content A includes “grains” and “roots”, a data feature is randomly selected from the data features as the candidate feature, for example: the data feature “grains” is selected as the candidate feature; or, two data features are randomly selected from the data features as the candidate features, for example: the data features “grains” and “roots” are used as the candidate features.

2. At least one data feature is selected from the data features corresponding to the training data-set as the candidate feature based on an exponential mechanism.

That is, the differential privacy is realized by an exponential mechanism, so that the training data is difficult to be deduced from model parameters corresponding to the finally-transmitted second decision tree model, thereby achieving a purpose of protecting the data privacy.

In an exemplary embodiment, after one candidate feature is selected from the data features, the candidate feature may be arranged back into the data features, that is, the selected candidate feature continues to participate in matching. The candidate feature may not be arranged back into the data features either, that is, the candidate feature is continuously selected from the data features that are not selected. The above is only an illustrative example, which is not limited by the embodiments of the present disclosure.

The candidate feature corresponds to at least two decision trends in the decision tree model. The decision trend indicates a feature case corresponding to the candidate feature, that is, the candidate feature has at least two classification cases, such as “a positive case” and “a negative case”.

In some embodiments, different candidate features may correspond to the same decision trend, for example: two decision trends of different candidate features are indicated by “yes” and “no”. Different candidate features may also correspond to different decision trends. For example: for the text content A, the data feature “grains” and the data feature “roots” correspond to different decision trends, wherein the decision trend corresponding to the data feature “grains” includes “clear” and “blurry”, which represents that the data feature “grains” correspondingly includes two feature cases, i.e., “clear grains” and “blurry grains”; and the decision trend corresponding to the data feature “roots” includes “curly”, “slightly curly”, and “upright”, which represents that the data feature “roots” correspondingly includes three feature cases, i.e., “curly roots”, “slightly curly roots”, and “upright roots”.

Step 320: Obtain n first decision tree models by taking the at least one candidate feature as the model construction foundation.

The value of n corresponds to the number of candidate features.

The decision tree model is a kind of prediction model, and is configured to indicate a mapping relationship among different candidate features. In the decision tree model, the candidate features exist in a form of nodes.

In an exemplary embodiment, a one-dimension decision tree model may be constructed through one candidate feature. By taking one candidate feature as a root node, all nodes having the association relationship with the candidate feature are leaf nodes, and a one-dimension decision tree model is constructed through the candidate feature. For example: the candidate feature is “whether the grains are clear”. The corresponding leaf node “yes” and leaf node “no” are generated according to the candidate feature. Therefore, one one-dimension decision tree model is constructed by the candidate feature alone.

The model construction foundation is the above-mentioned root node, internal nodes, and decision trends corresponding to the candidate feature. Through the candidate features and the decision trends corresponding to the candidate features, the internal nodes in the decision tree model may be determined gradually from the root node, and the corresponding leaf nodes are generated finally to implement the process of constructing the decision tree model.

Step 330: Determine at least one second decision tree model from n first decision tree models based on prediction results of the n first decision tree models for training data.

Schematically, after the first decision tree model is obtained according to the candidate feature, one or more first decision tree models with good prediction effect are selected from the first decision tree model as the second decision tree model, wherein the prediction effect is reflected by the prediction results of the n first decision tree models corresponding to the training data-set.

Step 340: Transmit the second decision tree model to the second computing device.

The second computing device is configured to receive the second decision tree model transmitted by the first computing device, and at least two decision tree models including the second decision tree model are fused to obtain a federated learning model.

In an exemplary embodiment, the first computing device transmits parameters corresponding to the second decision tree model to the second computing device. Schematically, as the decision tree model may be constructed based on the parameters of the decision tree model, after obtaining the second decision tree model, the first computing device transmits the parameters corresponding to the second decision tree model to the second computing device, and the second computing device may implement the process of constructing the second decision tree model based on the parameters of the second decision tree model.

In conclusion, the first computing device determines at least one candidate feature from the data features corresponding to the local training data-set, and constructs the n first decision tree models according to the candidate feature and the decision trends corresponding to the candidate feature; in order to make the first decision tree model more efficient in model prediction, at least one second decision tree model is selected from the n first decision tree models based on the prediction results of the n first decision tree models for the training data in the training data-set; the second decision tree model is transmitted to the second computing device; at least two decision tree models are fused by the second computing device to obtain the federated learning model; the first computing device obtains the second decision tree model based on the local training data, and there is no risk of privacy leakage; and at the same time, the first computing device transmits the second decision tree model to the second computing device for one time, and it is unnecessary to transmit the second decision tree model between the first computing device and the second computing device for multiple times, so that the consumption of excessive communication overhead is avoided, and the federated learning model is more convenient to construct.

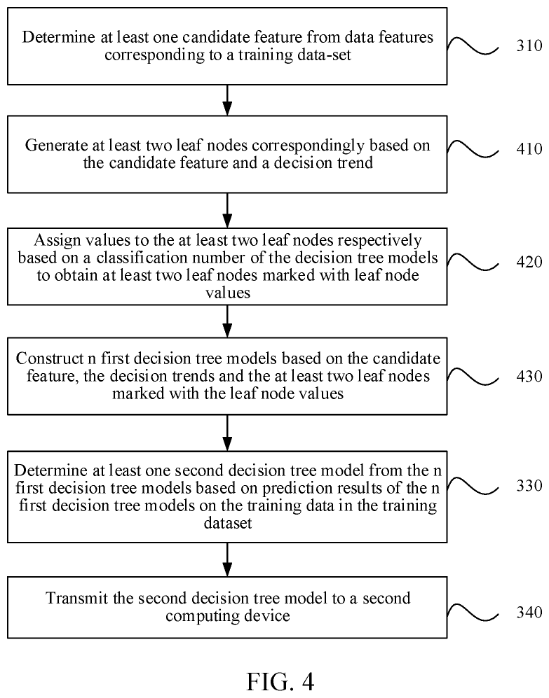

In an exemplary embodiment, the leaf nodes are generated based on the candidate feature and the decision trends corresponding to the candidate feature, and the first decision tree model is further obtained, wherein when the first decision tree model is of a binary classification, the assignment of the leaf nodes corresponding to each candidate feature is in two cases. Schematically, as shown in FIG. 4, step 320 in the embodiment shown in FIG. 3 may also be implemented as the following step 410 to step 430.

Step 410: Correspondingly generate at least two leaf nodes based on the candidate feature and the decision trends.

In some embodiments, the first candidate feature in the candidate features is used as a root node of the decision tree model.

The first candidate feature is any feature in the candidate features.

The root node is a starting point of the decision tree model. For a decision tree model, there is a unique root node corresponding to the decision tree model. Schematically, the root node is located at the topmost end of the decision tree model. The decision tree model is constructed according to the root node.

In some embodiments, after at least two candidate features are obtained, candidate feature is randomly selected from the at least two candidate features as the first candidate feature, and the first candidate feature is used as the root node of the decision tree model, that is, the decision tree model is constructed by taking the first candidate feature as the starting point.

In an exemplary embodiment, after the root node of the decision tree model is determined, obtaining the leaf nodes includes at least one of the following cases.

1. The leaf node having an association relationship with the root node is correspondingly generated based on the decision trend.

Each candidate feature has the corresponding decision trend. Schematically, one candidate feature is selected as the root node. The decision trends corresponding to the candidate feature include two cases, i.e., “yes” and “no”. When the decision trend corresponding to the candidate feature is “yes”, the candidate feature corresponds to one leaf node; and when the decision trend corresponding to the candidate feature is “no”, the candidate feature corresponds to another leaf node; and therefore, the one-dimension decision tree model can be constructed based on one candidate feature.

2. An associated node having the association relationship with the root node is correspondingly determined based on the decision trend corresponding to the root node; and the leaf node having the association relationship with the associated node is generated based on the decision trend corresponding to the association node.

The associated node indicates the second candidate feature. The second candidate feature is any feature in the candidate features other than the first candidate feature. That is, a connection relationship among the nodes in the decision tree model is constructed according to the decision trend, so as to ensure the data accuracy for the application of downstream decision tree models.

Schematically, a first candidate feature is randomly selected from the candidate features as the root node, and then the associated node having the association relationship with the root node is determined according to the decision trend corresponding to the first candidate feature. For example: when the association relationship between the candidate features is classified into “yes” and “no” (or classified by “1” and “0”), when there is the candidate feature having the association relationship with the root node, the candidate feature is used as the second candidate feature, and the candidate feature is different from the first candidate feature, that is, for selecting the second candidate feature, the first candidate feature is excluded from the candidate features first.

In some embodiments, in response to the construction of the decision tree model, the association relationship among the candidate features may be classified by the method of “yes” or “no”, and may also adopt a determination standard of multiple association relationships, such as: “excellent”, “good”, “medium”, “poor”, etc. The above is only an illustrative example, which is not limited by the embodiments of the present disclosure.

In an exemplary embodiment, after determining the first candidate feature and the decision trends corresponding to the first candidate feature, the second candidate feature having the association relationship with the first candidate feature is determined based on the first candidate feature and the decision trends. In some embodiments, in order to cover as many cases as possible, for different decision trends, the same second candidate feature is used as the associated node having the association relationship with the first candidate feature. Then a third candidate feature having the association relationship with the second candidate feature is determined based on the second candidate feature and the decision trends corresponding to the second candidate feature (or, by taking the second candidate feature as a new first candidate feature, the process of determining the third candidate feature according to the second candidate feature is regarded as a process of determining the new second candidate feature according to the new first candidate feature), and the above process is repeated, until the candidate feature cannot be determined according to the decision trend, and the leaf node having the association relationship with the last candidate feature is generated.

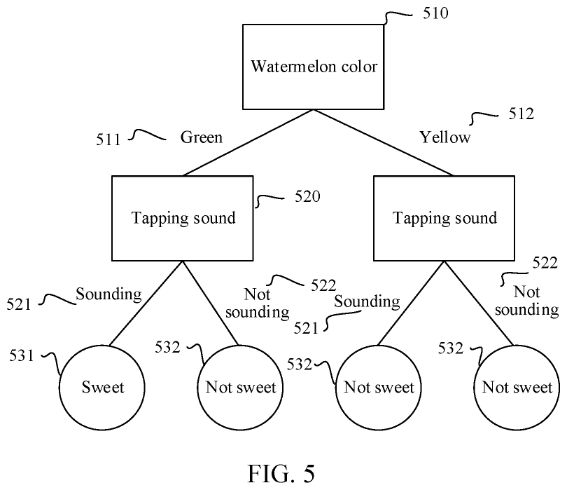

Schematically, as shown in FIG. 5, two candidate features are selected to construct the decision tree model. First, the root node is determined as watermelon color 510, that is, the first candidate feature is determined. The decision trends corresponding to the first candidate feature are in two cases, i.e., green 511 and yellow 512. The second candidate feature having the association relationship with the first candidate feature is tap sound 520, that is, when the decision trends of the first candidate feature are green 511 and yellow 512, the corresponding associated node is the tap sound 520. For the second candidate feature tap sound 520, when the watermelon color 510 is green 511, and the decision trend corresponding to the tap sound 520 is sounding 521, the leaf node to be generated is sweet 531; and when the watermelon color 510 is green 511, and the decision trend corresponding to the tap sound 520 is not sounding 522, the leaf node to be generated is not sweet 532. Similarly, when the watermelon color 510 is yellow 512, and the decision trend corresponding to the tap sound 520 is sounding 521, the leaf node to be generated is not sweet 532; and when the watermelon color 510 is yellow 512, and the decision trend corresponding to the tap sound 520 is not sounding 522, the leaf node to be generated is not sweet 532. In some embodiments, a conclusion obtained according to the decision tree includes: where the watermelon color is green and the tap sound is sounding, the watermelon is sweet.

Step 420: Assign values to at least two leaf nodes respectively based on the classification number of the decision tree model to obtain at least two leaf nodes marked with leaf node values.

In an exemplary embodiment, the decision tree model is a binary classification model. Based on the binary classification standard of the binary classification model, the leaf nodes are assigned with values to obtain at least two leaf nodes marked with the leaf node values.

The binary classification standard indicates that each leaf node has two assignment cases.

In some embodiments, in order to cover as many decision tree models as possible, the leaf nodes are assigned with values according to the binary classification standard. For example, the leaf nodes are assigned with “0 and 1”, that is, two assignment cases are provided for each leaf node. After the assignment of the leaf nodes, the leaf nodes assigned with the values are obtained. The leaf nodes assigned with the values are the leaf nodes with the leaf node values. The obtained decision tree model is associated with the leaf nodes assigned with the values.

That is, the leaf nodes are assigned with values through the binary classification standard corresponding to the binary classification model, so that the obtained first decision tree model can be enriched by using a simple data structure.

Step 430: Construct n first decision tree models based on the candidate feature, the decision trends, and at least two leaf nodes marked with leaf node values.

Schematically, D is used as the number of selected candidate features (or, a depth of the decision tree model), and D is a positive integer. After the candidate feature and the decision trend corresponding to the candidate feature are determined, according to the leaf nodes assigned with values (that is: the leaf nodes marked with the leaf node values), n decision tree models may be constructed. A relationship between n and D is shown in formula II.

Schematically, as shown in FIG. 1, when D=1, it indicates that one candidate feature 111 is selected. The candidate feature 111 has two leaf nodes (the leaf node 112 and the leaf node 113) corresponding to the candidate feature. The leaf nodes are assigned with values according to the binary classification standard. For example, the leaf nodes are assigned with the values “0 and 1”, that is, both the leaf node 112 and the leaf node 113 are provided with two assignment cases, i.e., 0 and 1 to obtain four corresponding decision tree models in FIG. 1, that is, n=2²^{¹}=4.

Assignment cases of the leaf nodes are respectively as follows: the leaf node 112 is assigned with 0, and the leaf node 113 is assigned with 0; the leaf node 112 is assigned with 0, and the leaf node 113 is assigned with 1; the leaf node 112 is assigned with 1, and the leaf node 113 is assigned with 0; and the leaf node 112 is assigned with 1, and the leaf node 113 is assigned with 1, thus obtaining four decision tree models according to different assignment cases of the leaf nodes.

Similarly, as shown in FIG. 2, when D=2, it indicates that two candidate features are selected. The association node associated with the candidate feature 211 is the candidate feature 212. The candidate feature 212 correspondingly generates four leaf nodes in different decision directions, i.e., the leaf node 213, the leaf node 214, the leaf node 215, and the leaf node 216. The leaf nodes are assigned with values according to a binary classification standard. For example, the leaf nodes are assigned with the values “0 and 1”, that is, the leaf node 213, the leaf node 214, the leaf node 215, and the leaf node 216 are all provided with two assignment cases, i.e., 0 and 1 to obtain sixteen corresponding decision tree models in FIG. 2, that is, n=2²^{²}=16.

The assignment cases of the leaf nodes are respectively as follows: the leaf node 213 is assigned with 0, the leaf node 214 is assigned with 0, the leaf node 215 is assigned with 0, and the leaf node 216 is assigned with 0; and the leaf node 213 is assigned with 0, the leaf node 214 is assigned with 0, the leaf node 215 is assigned with 0, and the leaf node 216 is assigned with 1, thus obtaining sixteen decision tree models according to different assignment cases of the leaf nodes.

The method provided by the present embodiment introduces a method for constructing the decision tree model. The leaf nodes are generated correspondingly by selecting the candidate feature and the decision trends corresponding to the candidate feature. The leaf nodes are assigned with values, so that the construction method of the obtained decision tree model can be considered more comprehensively, and more first decision tree models can be obtained. The candidate feature of the training data in the first computing device and the relationship among the candidate features may be more comprehensively known and more intuitively displayed by using the method, which facilitates the fusing operation of the second computing device on the decision tree model.

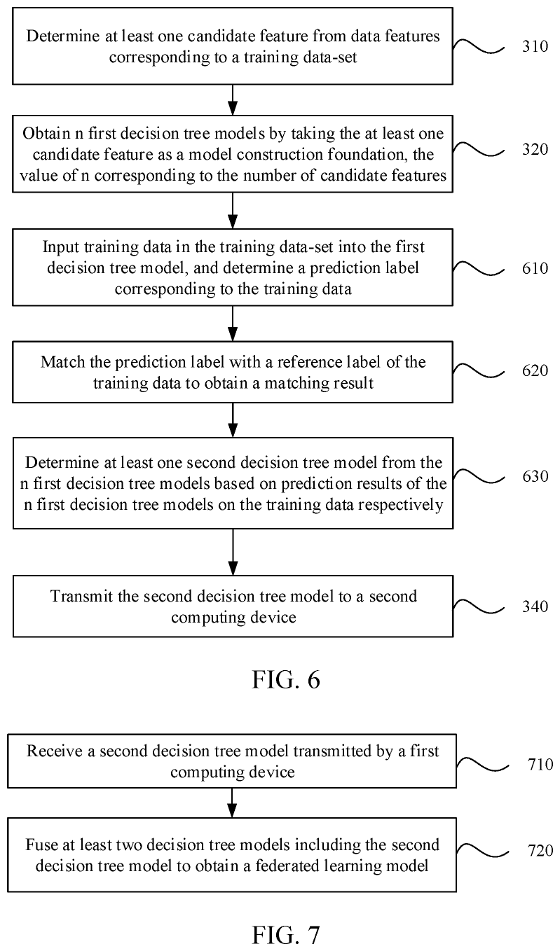

In an exemplary embodiment, after the first decision tree model is obtained, a second decision tree model is determined from the first decision tree models based on an exponential mechanism. Schematically, as shown in FIG. 6, step 330 in the embodiment shown in FIG. 3 can also be implemented as the following step 610 to step 630.

Step 610: Input training data in the training data-set into the first decision tree model, and determine a prediction label corresponding to the training data.

Schematically, the training data-set is a collection of training data, and includes a plurality of pieces of training data. The decision tree model is constructed through the selected candidate features. The candidate features are data features corresponding to the training data in the training data-set. In some embodiments, the training data inputted to the first decision tree model includes the training data providing the candidate feature, and also includes the training data in the training data-set but not providing the candidate feature.

It is to be noted that the training data can exist in a scattering form in the first computing device, that is, storing the training data in the training data-set is an illustrative example, which is not limited by the embodiments of the present disclosure.

In some embodiments, after the first decision tree model is obtained, training data is randomly selected from the training data-set and inputted into a first decision tree model, and the leaf node corresponding to the training data is determined according to the data feature corresponding to the training data. Schematically, the training data is a watermelon. There are multiple data features corresponding to the watermelon, including the color of the watermelon and the sound of tapping the watermelon. When the color of the watermelon is yellow, and the sound of tapping the watermelon is sounding, the leaf node corresponding to the training data is “not sweet”, and the “not sweet” is used as the prediction label corresponding to the training data “watermelon”. The prediction label is the leaf node value corresponding to the leaf node.

Step 620: Match the prediction label with a reference label of the training data to obtain a prediction result.

The reference label indicates a reference classification case of the training data.

In some embodiments, each training data in the training data-set is correspondingly marked with a reference label respectively. Schematically, the training data is a watermelon. The reference label corresponding to the training data is “sweet watermelon”, which indicates that the data feature corresponding to the training data can indicate that the “watermelon” is a “sweet watermelon”.

After a piece of training data is inputted into a plurality of first decision tree models obtained by training, a plurality of prediction labels corresponding to the training data can be obtained. The prediction label is the prediction result of the inputted first decision tree model for the training data. The reference label is a real result of the training data that is known in advance. In some embodiments, by matching the prediction label with the reference label, the corresponding prediction result of the training data in a plurality of first decision tree models may be obtained.

Step 630: Determine at least one second decision tree model from the n first decision tree models based on the corresponding prediction results of the n first decision tree models for the training data respectively.

After the training data is inputted into the n first decision tree models, a prediction effect of the n first decision tree models may be determined according to the prediction result. In some embodiments, according to the prediction effect, the best first decision tree model is selected from the n first decision tree models as the second decision tree model, or a plurality of first decision tree models with good effect are selected as the second decision tree model.

In an exemplary embodiment, matching scores respectively corresponding to the n first decision tree models are determined based on the corresponding prediction results of the n first decision tree models respectively for the training data; and at least one second decision tree model is determined based on the matching scores respectively corresponding to the n first decision tree models. That is, a model prediction effect corresponding to the first decision tree model is measured by calculating the matching scores corresponding to the first decision tree models, so that the second decision tree model may be determined from the n first decision tree models according to the matching scores, thereby ensuring the model prediction effect of the selected second decision tree model, and improving the model effect and the generation efficiency of the federated learning model generated at downstream.

Schematically, the prediction label is matched with a real label by using the exponential mechanism method to construct a score function corresponding to the first decision tree model. Schematically, a formula of the model score function is shown in formula III.

Hᵢ=Σₘ₌₁ⁿ1_{ŷ}_{_{i,m}}_{=y}_{ₘ} Formula III:

Hᵢ is a function expression of the score function corresponding to an i^{th} decision tree model; m indicates the m^{th} training data, and m is a positive integer; n indicates the number of the training data participating in the prediction in the training data-set, and n is a positive integer; ŷ_{i,m} indicates the i^{th} decision tree model and the prediction label of the m^{th} data; and yₘ is the reference label corresponding to the m^{th} training data. When ŷ_{i,m}=yₘ, the value of 1_{ŷ}_{_{i,m}}_{=y}_{ₘ} is 1; and when ŷ_{i,m}≠yₘ, the value of 1_{ŷ}_{_{i,m}}_{=y}_{ₘ} is 0.

In some embodiments, the prediction result includes a prediction success result and a prediction failure result. The prediction success result indicates that the corresponding prediction label after the training data passes through a certain decision tree model is the same as the reference label corresponding to the training data. The prediction failure result indicates that the corresponding prediction label after the training data passes through a certain decision tree model is different from the reference label corresponding to the training data.

Schematically, inputting the training data m into the first decision tree model i is taken as an example for description. After the training data m is inputted into the first decision tree model i, the prediction label ŷ_{i,m} (the leaf node value corresponding to the leaf node) of the training data m in the first decision tree model i may be determined according to the leaf node of the first decision tree model corresponding to the training data m, and the prediction label ŷ_{i,m} is matched with the reference label yₘ corresponding to the training data m to obtain the prediction result of the training data m and the first decision tree model i. The prediction result reflects a prediction about a difference between the prediction label and the reference label. After the training data is inputted into n first decision tree models, a prediction result of the training data in the n first decision tree models may be obtained. The prediction result may be determined by the above model score function, that is, the prediction effect between the prediction label and the reference label is measured by using the matching scores.

In an exemplary embodiment, the corresponding matching results include one of the following situations according to different prediction results.

1. In response to the prediction result being the prediction success result, bonus evaluation is performed on the first decision tree model corresponding to the prediction success result to obtain the matching score.

Schematically, in response to the prediction result being the prediction success result, that is, after the training data passes through a certain first decision tree model, the corresponding prediction label is the same as the reference label corresponding to the training data, the bonus evaluation is performed on the first decision tree model, for example: inputting the training data into the m^{th} first decision tree model is taken as an example for description; and letting the n first decision tree models have a score of 0 before predicting the training data, after one piece of training data passes through the m^{th} first decision tree model of the n first decision tree models, when the prediction label of the training data obtained by passing through the m^{th} first decision tree model is the same as the reference label corresponding to the training data, 1 is added to the m^{th} first decision tree model; and similarly, when 100 pieces of training data are stored in the training data-set, after all training data pass through the m^{th} first decision tree model of the n first decision tree models, when the prediction label of the 100 pieces of training data obtained by passing through the m^{th} first decision tree model are the same as the reference label corresponding to the 100 pieces of training data, the score of the m^{th} first decision tree model is 100, that is, the m^{th} first decision tree model succeeds in predicting all training data.

2. In response to the prediction result being the prediction failure result, retention evaluation is performed on the first decision tree model corresponding to the prediction failure result to obtain the matching score.

Schematically, when the prediction result is the prediction failure result, that is, after the training data passes through a certain first decision tree model, when the corresponding prediction label is different from the reference label corresponding to the training data, the retention evaluation is performed on the first decision tree model, that is, the score of the first decision tree model is kept unchanged. For example: letting the n first decision tree models have a score of 0 before predicting the training data, after the training data passes through the m^{th} first decision tree model of the n first decision tree models, when the prediction label corresponding to the training data is different from the reference label corresponding to the training data, the score of the m^{th} first decision tree model is kept unchanged and is still 0.

That is, by the bonus evaluation and retention evaluation methods, the matching score corresponding to the first decision tree model is determined according to the number of times when the prediction label is the same as the reference label to determine the matching score for determining the second decision tree model, so that the prediction accuracy corresponding to the second decision tree model screened according to the matching score is higher.

The above is only an illustrative example, which is not limited by the embodiments of the present disclosure.

In an exemplary embodiment, selection probabilities respectively corresponding to the n first decision tree models are determined based on the matching score; and the first decision tree model with the selection probability satisfying a preset probability condition is used as the second decision tree model.

The selection probability indicates the probability that the first decision tree model is selected as the second decision tree model.

Schematically, the selection probabilities respectively corresponding to the n first decision tree models are determined by using the exponential differential privacy mechanism based on the matching score to obtain the probability corresponding to the n decision tree models, and an expression of the model probability corresponding to the decision tree model is shown in formula IV

$$Formula IV : {β}_{i} = \frac{exp ( \frac{ε}{G * S} {H}_{i} )}{{\sum }_{j ∈ J} exp ( \frac{ε}{G * S} {H}_{j} )}$$

βᵢ is a function expression of the model probability corresponding to an i^{th} decision tree model; ε is a privacy overhead consumed for selecting the model and is a preset positive number; S is the number of second decision tree models selected from the first decision tree models, and S is a positive integer; G indicates the number of repeating the construction of first decision tree model and determining the decision tree model from the first decision tree model, G can be 1, that is, the process is only carried out for one time, and can also be a positive integer greater than 1, that is, the process is repeated for multiple times; Hᵢ is a function expression of the score function corresponding to the i^{th} decision tree model; Hⱼ is a function expression of the score function corresponding to j^{th} decision tree model; J indicates an index set of the first decision tree models; and j indicates the j decision tree models.

Based on the determined model probability corresponding to the first decision tree model, the model probability is compared with the preset probability condition, and the first decision tree model satisfying the preset probability condition is used as the decision tree model.

Schematically, the preset probability condition is to select X first decision tree models with highest model probability, X is a positive integer, that is, the preset probability condition includes a model probability condition and a decision tree model condition, wherein the model probability condition may be determined according to a sequencing result of the model probability, and the decision tree model condition is that the number of the selected first decision tree models is X, for example: after obtaining the first decision tree model, the model probability is sequenced in a descending order to obtain a descending sequence result; and the first decision tree model corresponding to the first X model probability in the descending sequence result is selected, and the selected first decision tree model is used as the decision tree model; or, the preset probability condition is to select the first decision tree model with the model probability greater than 0.5, that is, the model probability condition is set in the preset probability condition, for example: after obtaining the model probability, the first decision tree model corresponding to the model probability greater than 0.5 is selected, and the selected first decision tree model is used as the decision tree model.

In the embodiments of the present disclosure, the second decision tree model is selected from the first decision tree models by using the exponential mechanism method, that is, by inputting the training data in the training data-set into the constructed first decision tree model, the corresponding prediction label of the training data in each first decision tree model can be determined. The prediction label is matched with the reference label corresponding to the training data to obtain the prediction result that may be used as a condition for determining the second decision tree model. By the above method, the second decision tree model with better prediction effect may be selected from the first decision tree models, which is conducive to achieving better fusion effect of the federated learning model.

In an exemplary embodiment, the federated learning method is applied to the second computing device. Schematically, as shown in FIG. 7, the method includes the following steps.

Step 710: Receive a second decision tree model transmitted by a first computing device.

The first computing device is configured to determine at least one candidate feature from data features corresponding to a training data-set, the candidate feature corresponding to at least two decision trends in a decision tree model; obtain n first decision tree models by taking the at least one candidate feature as a model construction foundation, the value of n corresponding to the number of the candidate features; and determine at least one second decision tree model from the n first decision tree models according to prediction results of the n first decision tree models on training data in the training data-set.

Step 720: Fuse at least two decision tree models including the second decision tree model to obtain a federated learning model.

In some embodiments, the second decision tree models may be the same, for example: the candidate feature, decision trends, and assignment cases of leaf nodes in the second decision tree model are the same. When two second decision tree models to be compared are the same, a duplicate removal operation is performed on the two selected second decision tree models. Schematically, any one of the two selected second decision tree models is removed, that is, any one of the second decision tree models is deleted, and the other second decision tree model is reserved.

In some embodiments, the second computing device includes at least one of the following implementations according to different application scenarios.

1. The second computing device is implemented as a federated server.

The federated server is a server or a terminal applied to a federated learning scenario. In some embodiments, when the second computing device is implemented as the server, correspondingly, the first computing device can be implemented as a server, a terminal or a runtime server in the terminal, etc.; when the second computing device is implemented as the terminal, correspondingly, the first computing device can be implemented as a terminal or a runtime server on the terminal, etc.

Schematically, when the second computing device is implemented as the federated server, and the first computing device is implemented as a plurality of terminals connected with the federated server, the second computing device receives a plurality of decision tree models transmitted by the first computing device, and fuses a plurality of decision tree models transmitted by different terminals to obtain a federated learning model. For example: at least two first computing devices are application servers corresponding to different film and television application programs; the second computing device is the federated server for performing federated learning; and each application server stores the training data corresponding to different user identifications, for example, the training data includes historical interaction data corresponding to the user identification, such as historical watching information, historical like information or historical collection information, etc. The historical interaction data is the data obtained after being authorized by the user. Each application server adopts the method provided by the embodiments of the present disclosure to locally construct a plurality of first decision tree models at a local terminal through the candidate features in the local training database. The historical interaction data is inputted into a plurality of first decision tree models. The historical interaction data is predicted by the plurality of first decision tree models to obtain the prediction result. The prediction result includes interest points of users obtained by predicting the inputted historical interaction data. Based on the prediction results of different first decision tree models on the historical interaction data, the second decision tree model is selected from the first decision tree models. The second decision tree model is a decision tree model that can reflect the interest point of the user to a great extent. Then the second decision tree model is transmitted to the federated server. The decision tree models of a plurality of application servers are fused by the federated server to obtain the federated learning model. The federated learning model is transmitted to each application server. The federated learning model is configured to recommend content to users, such as recommending items that meet the interest points of the users based on the corresponding data characteristics of users.

2. The second computing device is implemented as the federated computing device.

The federated computing device refers to a state that different computing devices run in parallel.

Schematically, the first computing device and the second computing device are two computing devices running in parallel. The first computing device and the second computing device construct a plurality of first decision tree models respectively by using the local training data. Based on the exponential mechanism, the first computing device selects the second decision tree model to be transmitted to the second computing device from the first decision tree models, and the second computing device selects the local decision tree model to be transmitted to the first computing device from the first decision tree models. Then the first computing device transmits a plurality of second decision tree models that are constructed and selected based on the local training data to the second computing device. The second computing device also transmits a plurality of local decision tree models that are constructed and selected based on the local training data to the first computing device, that is, the decision tree model is exchanged between the first computing device and the second computing device, so that the first computing device and the second computing device may own the decision tree model of the other party. The first computing device fuses a plurality of local second decision tree models and a plurality of received local decision tree models transmitted by the second computing device. The second computing device fuses a plurality of local decision tree models and a plurality of received second decision tree models transmitted by the first computing device. Through the respective fusion process, the first computing device and the second computing device may achieve a purpose of effectively mining data values on the premise of protecting the user privacy.

For example: a first computing device and a second computing device correspond to application servers of two electronics companies respectively, and the training data stored in each application server is data corresponding to a network troubleshooting method. The two application servers adopt the method provided by the embodiments of the present disclosure to construct a plurality of first decision tree models on a local terminal respectively through the candidate features in the local training database, and input the data corresponding to the network troubleshooting method into a plurality of first decision tree models, and the data is predicted by a plurality of first decision tree models to obtain a prediction result. The prediction result includes the network troubleshooting method obtained by predicting the inputted data. Based on the prediction result of different first decision tree models on the above data, the decision tree model is selected from the first decision tree models. The decision tree model is a decision tree model that can reflect the network troubleshooting method to a great extent. Then the decision tree model is transmitted to the application server of the other party. The application server of each party fuses the own decision tree model and the decision tree model of the other party to obtain the federated learning model, which is conducive to providing the troubleshooting method or performing early warning for new troubles of the electronics companies, thereby improving the trouble detection accuracy of the device. The above is only an illustrative example, which is not limited by the embodiments of the present disclosure.

In an exemplary embodiment, the second decision tree model with the same features as the local decision tree model to obtain a decision tree model group; an average classification value is obtained based on the classification probability corresponding to each decision tree model in the decision tree model group. The federated learning model is obtained based on a matching result of the average classification value and a preset classification threshold.

Schematically, one first computing device corresponding to one second computing device is taken as an example for description. After receiving the second decision tree model transmitted by the first computing device, the second computing device compares the local decision tree model with a plurality of second decision tree models transmitted by the first computing device one by one, In some embodiments, when the features of the decision tree model are the same, the local decision tree model and the second decision tree model are combined into a decision tree model group. Schematically, a leaf node corresponding to the feature is determined according to a position of the feature in any decision tree model in the decision tree model group. By taking the candidate feature and any corresponding leaf node as analysis objects, the probability that the candidate feature reaches the leaf node is determined. For example: when the feature is “whether the grains are clear”, and the leaf node associated with the feature is a “bad melon”, the probability of the feature “whether the grains are clear” to the leaf node “bad melon” is 0.5, and the probability is the classification probability corresponding to the decision tree model.

In some embodiments, the above classification result operation is performed on other decision tree models with the same features in the decision tree model group and the corresponding leaf nodes to obtain the probability from the feature to the corresponding leaf node in other decision tree models in the decision tree model group. The probabilities corresponding to the classification results in different candidate training models are averaged to obtain an average probability that the classification results correspond to the feature. Schematically, a preset probability threshold is set in advance or the preset probability threshold is determined according to the number of types of the leaf nodes. When the average probability that the classification results correspond to the candidate feature is greater than the preset probability threshold, the leaf node corresponding to the classification result greater than the preset probability threshold is used as a classification result corresponding to the candidate feature in the federated learning model.

For example: the preset probability threshold is determined according to the number of types of leaf nodes, the number of the types of leaf nodes is 2, the leaf nodes are “good” and “not good” respectively, and the preset probability threshold is 0.5. When the average probability of the selected feature and the classification result with the same association with the feature is greater than 0.5, the leaf node corresponding to the classification result that is greater than 0.5 is taken as the leaf node corresponding to the candidate feature in the federated learning model. When the corresponding leaf node with the classification result greater than 0.5 is “good”, the leaf node “good” is used as the candidate feature in the federated learning model and the leaf node with the same association with the candidate feature to construct the federated learning model.

In some embodiments, after obtaining the federated model, the second computing device can analyze at least one piece of local analysis data based on the federated learning model to obtain a data analysis result.

In some embodiments, when the second computing device is implemented as the federated computing device, the second computing device analyzes the local analysis data based on the fused federated learning model to obtain the data analysis result. Similarly, the first computing device fuses the second decision tree models that are constructed and selected on the local terminal and the local decision tree model transmitted by the second computing device to obtain the federated learning model, and the federated learning model may also be configured to analyze the analysis data stored in the first computing device to obtain the data analysis result.

In some other embodiments, the second device may transmit the federated learning model to the first computing device. The first computing device is configured to analyze at least one piece of local analysis data based on the federated learning model to obtain the data analysis result.

In an exemplary embodiment, the federated learning model is fused by the second computing device based on a plurality of decision tree models transmitted by at least one first computing device, for example: the decision tree models constructed by a plurality of first computing devices are fused in the federated learning model, or the decision tree model constructed by one first computing device and the decision tree model constructed by one second computing device are fused in the federated learning model. Therefore, the candidate features of multi-party training data are fused in the federated learning model. Schematically, after obtaining the federated learning model, the second computing device transmits the federated learning model to the first computing device, so that based on the own local data, the first computing device may use the candidate features of other computing devices (including the first computing device, and also including the second computing device) contained in the federated learning to analyze the local analysis data to obtain the data analysis result, thereby further mining the data values.

In the embodiments of the present disclosure, the process of transmitting the federated learning model to the first computing device after the second computing device obtains the federated learning model is introduced. By transmitting the comprehensive and accurate federated learning model to the first computing device, each first computing device may further mine the own local data on the premise of protecting the data privacy, so that new solutions may be provided for cross-department, cross-organization, and cross-industry data cooperation on the premise of avoiding direct data transmission.

Often, after the participant transmits the encrypted model parameters to the federated server, the federated server adjusts the model parameters and also needs to transmit the adjusted model parameters to the participant in an encryption manner. Therefore, the federated server also consumes vast computing resources in the own encryption process and multiple parameter transmission processes.

According to the federated learning method provided by the embodiments of the present disclosure, in the second computing device serving as a model fusion terminal, since the received second decision tree models are trained by the first computing device, the second computing device may fuse the received second decision models to obtain the federated learning model, and use the federated learning model on the local terminal, or transmit the federated learning model to the opposite terminal, so that the transmission resource used by the corresponding overall data is reduced.

At the same time, the second decision tree models in the present solution may be transmitted between the first computing device and the second computing device in a plain-text manner. The second computing device is unnecessary to decipher the received second decision tree models. When the federated learning model is transmitted to the first computing device, it is also unnecessary to encrypt the federated learning model, so that the consumption of computing resources in the process in which the second computing device realizes the federated learning is reduced.

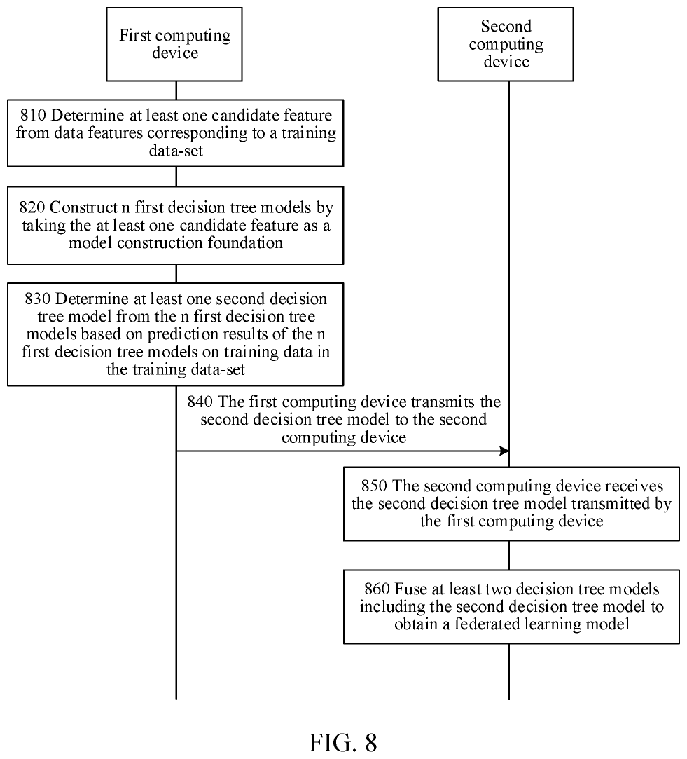

In an exemplary embodiment, by taking the federated learning system including the first computing device and the second computing device and an interaction process between the two computing devices as an example, the federated learning method provided by the embodiments of the present disclosure is described. As shown in FIG. 8, a flowchart of a federated learning method provided by another exemplary embodiment of the present disclosure is shown. The method is implemented as the following step 810 to step 860.

Step 810: The first computing device determines at least one candidate feature from data features corresponding to a training data-set.

In some embodiments, the candidate feature may be determined by a random selection method or a method based on an exponential mechanism from data features corresponding to the training data-set.

The training data is correspondingly marked with a data label. The data feature is matched with the data label to obtain a matching case. The matching case may be expressed by a score function. The score function is constructed through the exponential mechanism. An expression of the score function is shown in formula V and formula VI.

Σₘ₌₁^{M}1_{X}_{_{m,n}}_{=y}_{ₘ} Formula V:

Q_{|I|+n}=Σₘ₌₁^{M}1_{1-X}_{_{m,n}}_{=y}_{ₘ} Formula VI:

In the formula, m indicates the m^{th} training data, and m is a positive integer; M indicates that there are m pieces of training data in total, and m is a positive integer; I indicates a collection of data features; n indicates an n^{th} data feature in the m^{th} training data; X_{m,n} indicates a unique hot code value of the n^{th} data feature corresponding to the m^{th} training data; yₘ indicates a data label; 1_{X}_{_{m,n}}_{=y}_{ₘ} indicates that in a case of X_{m,n}=yₘ, an output is 1, and otherwise, the output is 0; and 1_{1-X}_{_{m,n}}_{=y}_{ₘ} indicates that in a case of 1−X_{m,n}=yₘ, the output is 0, and otherwise, the output is 1, that is, either X_{m,n}=yₘ or 1−X_{m,n}=yₘ is established, and can use the above score function.

Then the prediction results are normalized based on the exponential mechanism to determine the target probability that each training data is selected as the candidate feature. Schematically, the expression of the target probability is shown in Formula VII.

$$Formula VII : {θ}_{n} = \frac{exp ( \frac{{ε}_{1}}{L} {Q}_{n} )}{{\sum }_{j = 1}^{\vert I \vert} exp ( \frac{{ε}_{1}}{L} {Q}_{j} ) + {\sum }_{j = 1}^{\vert I \vert} exp ( \frac{{ε}_{1}}{L} {Q}_{\vert I \vert + j} )}$$

θₙ indicates the probability that the data feature is selected, ε₁ is a preset total amount of privacy overhead for selecting the data feature and is a preset positive integer,

$$\frac{{ε}_{1}}{L}$$

indicates the privacy overhead consumed for selecting the data feature in a case of selecting L data features, Qₙ indicates the prediction result of the n^{th} data feature, and indicates the matching case of the n^{th} data feature in the m^{th} training data and the data label corresponding to the m^{th} training data; I indicates a collection of data features; j indicates a j^{th} data feature which is contained in the data feature set I; and Qⱼ indicates the prediction result of the j^{th} data feature.

The candidate feature corresponds to at least two decision trends in the decision tree model.

Step 820: The first computing device obtains n first decision tree models by taking at least one candidate feature as a model construction foundation.

The value of n corresponds to the number of candidate features.

Step 830: The first computing device determines at least one second decision tree model from the n first decision tree models based the prediction results of the n first decision tree models for the training data in the training data-set.

The decision tree model is a kind of prediction model, and is configured to indicate a mapping relationship among different candidate features. In the decision tree model, the candidate features exist in a form of nodes. One decision tree model is taken as an example for description. The decision tree model includes root nodes, leaf nodes, and internal nodes. The construction foundation of nodes is the above-mentioned root nodes, internal node, and association relationship corresponding to the candidate features. Through the candidate features and the association relationship corresponding to the candidate features, the internal nodes in the decision tree model can be determined step by step from the root nodes, and finally the leaf nodes may be generated, thereby realizing the process of constructing the decision tree model.

Step 840: The first computing device transmits the second decision tree model to the second computing device.

Step 850: The second computing device receives the second decision tree model transmitted by the first computing device.

Step 860: The second computing device fuses at least two decision tree models including the second decision tree model to obtain a federated learning model.

In some embodiments, the second decision tree models may be the same, for example: the candidate features, decision trends, and assignment cases of the leaf nodes in the second decision tree models are the same, and when two second decision tree models to be compared are the same, a duplicate removal operation is performed on the two selected second decision tree models. Schematically, any one of the two selected second decision tree models is removed, that is, any one of the second decision tree models is deleted, and the other second decision tree model is reserved.

In some embodiments, when a plurality of first computing devices are connected with one second computing device, after the second computing device performs the duplicate removal operation on the second decision tree model, at least two reserved second decision tree models are fused to obtain the federated decision tree model; when one first computing device is connected with one second computing device, after the second computing device performs the duplicate removal operation on the second decision tree model transmitted by the other party and the decision tree model constructed and selected by the local terminal, at least two reserved decision tree models (the second decision tree model or the local decision tree model) including the second decision tree model are fused to obtain the federated decision tree model.

In conclusion, the first computing device determines at least one candidate feature from the data features corresponding to the local training data-set, constructs n first decision tree models according to the candidate feature and the decision trends corresponding to the candidate feature, selects at least one second decision tree model from the n first decision tree models based on the prediction results of the n first decision tree models for the training data in the training data-set, and transmits the second decision tree model to the second computing device. At least two decision tree models are fused by the second computing device to obtain the federated learning model. The first computing device obtains the second decision tree model based on the local training data, which has no risk of privacy leakage. At the same time, the first computing device transmits the second decision tree model to the second computing device for one time, and it is unnecessary to transmit the second decision tree model between the first computing device and the second computing device for multiple times, so that the consumption of excessive communication overhead is avoided, and the federated learning model is more convenient to construct.

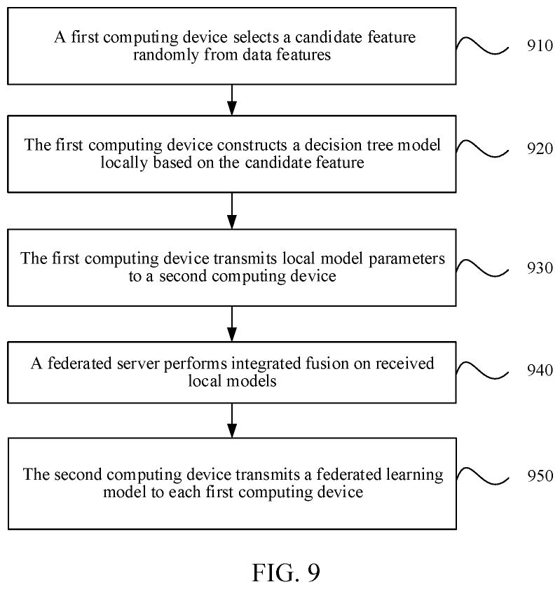

In an exemplary embodiment, the above federated learning model is applied to the horizontal federated learning, as shown in FIG. 9, in the technical solutions provided by the embodiments of the present disclosure, each first computing device of the horizontal federated learning randomly selects the feature and constructs the decision tree model locally, and then transmits the decision tree model selected based on the exponential mechanism to the second computing device. The second computing device integrates and fuses the received decision tree models, and then transmits the obtained federated learning model to each first computing device. Schematically, as shown in FIG. 9, in the provided horizontal federated integrated learning method, a training process of the federated learning model is implemented as the following step 910 to step 950.

Step 910: The first computing device selects a candidate feature randomly from the data features.

Each first computing device uses the own local training data to randomly select the features at a local terminal, for example, randomly select all features at an equal probability.

Step 920: The first computing device constructs the decision tree model locally based on the candidate feature.

After selecting the local features, each first computing device constructs the decision tree model with a depth D based on the candidate feature.

In some embodiments, for a group of feature sets (D features), since each feature has two cases, i.e., 0 and 1, T=2²^{^{D}} decision tree models can be constructed for the binary classification model. Considering the i^{th} decision tree model and the m^{th} data and the leaf node value ŷ_{i,m} corresponding to the training data, the score function may be obtained through a prediction result ŷ_{i,m}·S decision tree models are selected from T decision tree models by using the exponential differential privacy mechanism. By repeating the random selection of D features and the construction of the decision tree model for G times, a total of (G*S) decision tree models with the depth of D can be obtained.

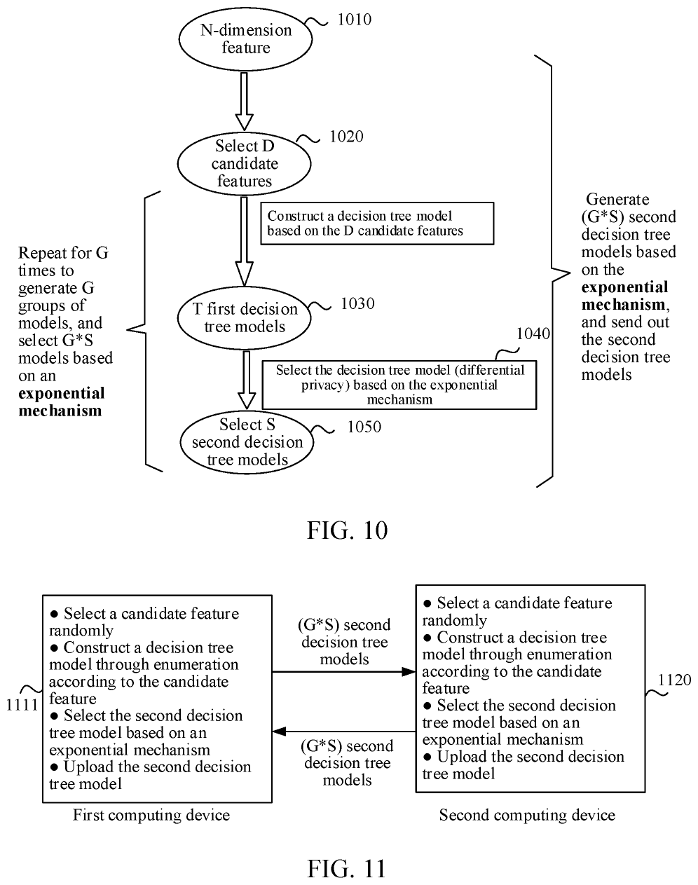

In an exemplary embodiment, the step 910 to the step 920 may be implemented as shown in FIG. 10. Firstly, the N-dimension feature 1010 corresponding to the training data is obtained based on the training data, and then D candidate features 1020 are selected randomly from the N-dimension features. Then T binary classification decision tree models 1030 are obtained based on the D candidate features, where T=2²^{^{D}}. Then the decision tree model selection 1040 is performed based on the exponential mechanism to select S decision tree models 1050 from the T decision tree models. In some embodiments, after obtaining the S decision tree models, the process of selecting the D candidate features 1020 and the process of selecting the S decision tree models 1050 are repeated for G times, that is, G groups of models are generated to obtain G*S models.

Step 930: The first computing device transmits local model parameters to the second computing device.

After completing the local model training, each first computing device transmits the locally obtained model to the second computing device in a plain-text form. Each first computing device may generate G*S models, and each model includes the model parameters corresponding to the decision tree models, including: candidate features, decision trends, and corresponding leaf node values.

Step 940: A federated server integrates and fuses the received local models.

After receiving the local model or model parameters transmitted by at least one first computing device, the second computing device integrates and fuses the received local models to obtain a federated learning model. The second computing device may perform federated voting fusion on the received local models of the first computing device. The voting integration method is generally used in the classification model. For example, for a binary classification model (positive and negative), a classification result of the federated voting model is determined by an average value of the classification results of local models of the first computing device. For a certain piece of to-be-classified data, when the average value of the classification result of the local model of the first computing device is greater than 0.5, the classification result of the federated voting model is “positive”. Otherwise, when the average value of the classification result of the local model of the first computing device is less than 0.5, the classification result of the federated voting model is “negative”. When the average value is equal to 0.5, a random selection method can be used simply. Due to a plurality of first computing devices and the use of exponential differential privacy mechanism, the model may be repeated. Before the fusion, the repeated model is removed, that is, only one of the repeated models is reserved.

Step 950: The second computing device transmits the federated learning model to each first computing device.

In some embodiments, the federated learning model is obtained by fusing, by the second computing device, a plurality of decision tree models transmitted by each first computing device. Schematically, after obtaining the federated learning model, the second computing device transmits the federated learning model to the first computing device, so that based on the local data, the first computing device may use the candidate features of other computing devices (including the first computing device, and also including the second computing device) contained in the federated learning to analyze the local analysis data to obtain the data analysis result, thereby further mining the data values.

An embodiment of the present disclosure provides a federated integrated learning method of a decision tree based on an exponential mechanism, and particularly relates to a horizontal federated learning method updated in parallel. Schematically, the process from the step 911 to the step 950 may be implemented as FIG. 11. As shown in FIG. 11, a model training system includes a second computing device 1120 and a first computing device 1111. Each first computing device 1111 stores a plurality of pieces of training data. Each training data is correspondingly marked with a data label, and corresponds to a plurality of data features.

The first computing device 1111: The first computing device 1111 selects a candidate feature randomly from data features; then the first computing device 1111 constructs a decision tree model through enumeration according to the selected candidate feature, and selects the decision tree model which can better reflect the training data from the first decision tree models by using the method of exponential mechanism, so as to realize the process of selecting the decision tree model based on the exponential mechanism; and finally, the first computing device 1111 transmits the decision tree model to the second computing device 1120 to realize a model uploading process.

The second computing device 1120: after receiving the decision tree models transmitted by the first computing device 1111, the second computing device 1120 fuses the decision tree models.

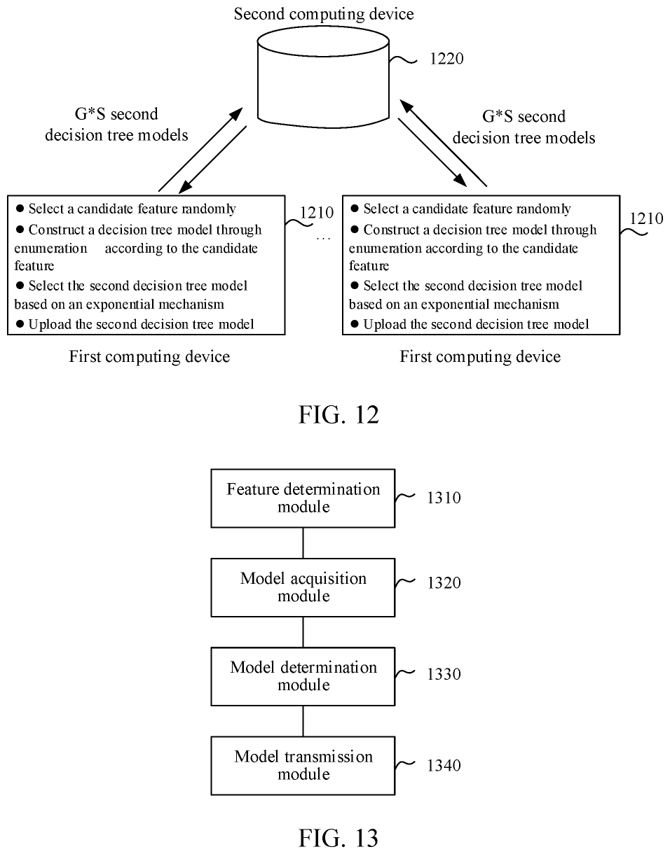

An embodiment of the present disclosure provides a federated integrated learning method based on an exponential mechanism and a decision tree, and particularly relates to a horizontal federated learning method updated in parallel. Schematically, the process from the step 910 to the step 950 may be implemented as FIG. 12. As shown in FIG. 12, a model training system includes a second computing device 1220 and k first computing devices 1210, wherein k is an integer greater than 1. Each first computing device 1210 stores a plurality of pieces of training data. Each training data is correspondingly marked with a data label, and corresponds to a plurality of data features.

The first computing device 1210: The first computing device 1210 selects a candidate feature randomly from data features; then the first computing device 1210 constructs a decision tree model through enumeration according to the selected candidate feature, and selects the decision tree model which can better reflect the training data from the first decision tree models by using the method of exponential mechanism, so as to realize the process of selecting the decision tree model based on the exponential mechanism; and finally, the first computing device 1210 transmits the decision tree model to the second computing device 1220 to realize a model transmission process.

The second computing device 1220: after receiving the decision tree models transmitted by the first computing device 1210, the second computing device 1220 fuses the decision tree models.

It is to be noted that, in the process of training the federated learning model, each first computing device may transmit the decision tree model to the second computing device. In an exemplary embodiment, different first computing devices may transmit the decision tree models to the second computing device simultaneously or successively or in other various manners. The same first computing device may also transmit the decision tree models to the second computing device simultaneously or successively, which is not limited by the embodiments of the present disclosure.

In conclusion, the first computing device determines at least one candidate feature from the data features corresponding to the local training data-set, constructs n first decision tree models according to the candidate feature and the decision trends corresponding to the candidate feature, then selects at least one second decision tree model from the n first decision tree models based on the prediction results of the n first decision tree models for the training data in the training data-set, and transmits the decision tree models to the second computing device, and the at least two decision tree models are fused by the second computing device to obtain the federated learning model. Through the above method, the first computing device obtains the second decision tree model based on the local training data, which has no risk of privacy leakage. At the same time, it is unnecessary to transmit the second decision tree model between the first computing device and the second computing device for multiple times, so that the consumption of excessive communication overhead is avoided, and the federated learning model is more convenient to construct.

By using the federated learning method provided by the embodiments of the present disclosure, each participant needs to transmit the local training model to the federated server only for one time in a plain-text form. The federated model obtained by the method in the embodiments of the present disclosure may be applied to various data analysis scenarios.

In some embodiments, the federated learning method provided by the embodiments of the present disclosure may be applied to the field of intelligent recommendation. Schematically, at least two first computing devices are application servers corresponding to different film and television application programs; and the second computing device is a federated server for performing federated learning.

Each application server stores the training data corresponding to different user identifications, for example, the training data includes historical watching information, historical like information or historical collection information corresponding to the user identification. Due to the privacy of user-related data stored by different application servers, the application servers cannot transmit the own stored user-related data to other servers as the training data-set so as to protect the privacy.

Therefore, by adopting the federated learning method provided by the embodiments of the present disclosure, each application server uses the user-related data stored in the local terminal as the training data-set, determines at least one candidate feature from the data features corresponding to the training data-set, and obtains the first decision tree models corresponding to the number of the candidate features by taking the at least one candidate feature as the model construction foundation, and determines at least one second decision tree model from the first decision tree models according to the prediction results of the first decision tree models for the training data in the training data-set, wherein the second decision tree model is a model which can perform content recommendation according to the preference of the user after learning the user-related data in the local terminal. That is, the application server obtains the second decision tree models by training at the local terminal, and transmits the second decision tree models to the federated server. The federated server receives the second decision tree models from a plurality of application servers, and fuses the second decision tree models to obtain the federated learning model. The federated learning model fuses and learns the features of the training data-sets corresponding to different application servers. The federated server transmits the federated learning model back to each application server again. The application server performs content recommendations to a user account through the federated learning model, such as video recommendation, article recommendation, music recommendation, friend recommendation, etc.

In some other embodiments, the federated learning method provided by the embodiments of the present disclosure can also be applied to the field of fault detection. Schematically, at least two first computing devices are application servers corresponding to different electronic machinery companies. The second computing device is the federated server for performing the federated learning. Each application server stores training data related to equipment faults recorded by different electronic machinery companies, for example, the training data is causes of vehicle faults or a network troubleshooting method. Each application server adopts the method provided by the embodiments of the present disclosure to construct the first decision tree models at the local terminal through the data features corresponding to the local training data and the data labels corresponding to the training data, determine the second decision tree model from the first decision tree models, and transmit the trained second decision tree model to the federated server. The federated server fuses the second decision tree models of the plurality of application servers to obtain the federated learning model. The federated learning model is transmitted to each application server, which can facilitate the subsequent early warning for fault problems based on the electronic machinery companies, thereby improving the fault detection accuracy of the equipment.

In some other embodiments, the federated learning method provided by the embodiments of the present disclosure can also be applied to the medical field. Schematically, at least two first computing devices are application servers corresponding to different hospitals; and the second computing device is a federated server for performing the federated learning. Each application server stores the training data corresponding to different patients. For example, the training data is medical history information of the patients or department information of the hospitals, etc. Each application server adopts the method provided by the embodiments of the present disclosure to construct the first decision tree models at the local terminal through the local training data, determine the second decision tree model from the first decision tree models, and transmit the trained second decision tree model to the federated server. The federated server fuses the decision tree models of the plurality of application servers to obtain the federated learning model. Then the federated learning model may be transmitted to various application servers, which may not only protect the user privacy, but also may provide assistant suggestions for doctors during the disease diagnosis according to a disease prediction result and other information of the user.

FIG. 13 is a structural block diagram of a federated learning apparatus provided by an exemplary embodiment of the present disclosure. As shown in FIG. 13, the apparatus includes the following parts:
a feature determination module 1310, configured to determine at least one candidate feature from data features corresponding to a training data-set, the candidate feature corresponding to at least two decision trends in a decision tree model;
a model acquisition module 1320, configured to obtain n first decision tree models by taking the at least one candidate feature as a model construction foundation, the value of n corresponding to the number of the candidate features;
a model determination module 1330, configured to determine at least one second decision tree model from the n first decision tree models based on prediction results of the n first decision tree models on training data in the training data-set; and
a model transmission module 1340, configured to transmit the second decision tree model to a second computing device, the second computing device being configured to receive the second decision tree model transmitted by the first computing device, and fuse at least two decision tree models including the second decision tree model to obtain a federated learning model.

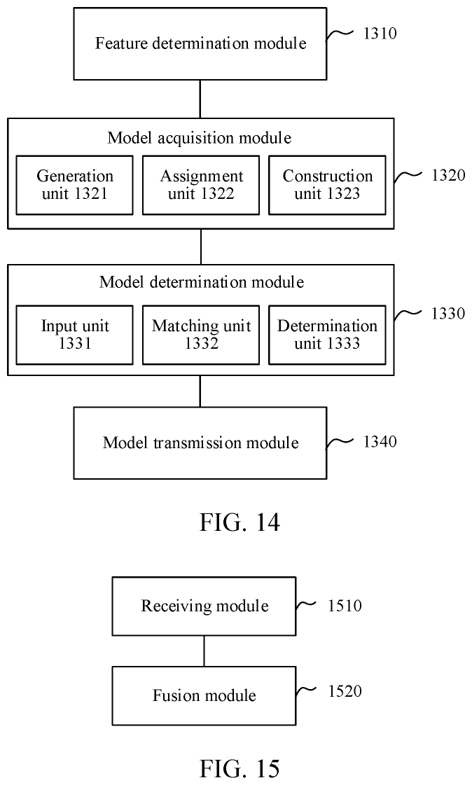

As shown in FIG. 14, in an exemplary embodiment, the model acquisition module 1320 includes:
a generation unit 1321, configured to correspondingly generate at least two leaf nodes based on the candidate feature and the decision trends;
an assignment unit 1322, configured to assign values to the at least two leaf nodes respectively based on the classification number of the decision tree model to obtain at least two leaf nodes marked with leaf node values; and
a construction unit 1323, configured to construct the n first decision tree models based on the candidate feature, the decision trends, and at least two leaf nodes marked with the leaf node values.

In an exemplary embodiment, the decision tree model is a binary classification model.

The assignment unit 1322 is configured to assign values to the leaf nodes based on a binary classification standard of a binary classification model to obtain at least two leaf nodes marked with the leaf node values, and the binary classification standard indicates that each leaf node has two assignment cases.

In an exemplary embodiment, the generation unit 1321 is configured to use a first candidate feature in the candidate features as a root node of the decision tree model, the first candidate feature being any feature of the candidate features; correspondingly generate the leaf node having an association relationship with the root node based on the decision trends; or, determine an associated node having an association relationship with the root node based on the decision trends corresponding to the root node, the associated node indicating the second candidate feature, the second candidate feature being any feature in the candidate features other than the first candidate feature; and generate the leaf node having the association relationship with the associated node based on the decision trends corresponding to the associated node.

In an exemplary embodiment, the model determination module 1330 includes:
an input unit 1331, configured to input the training data in the training data-set into the first decision tree model, and determine a prediction label corresponding to the training data;
a matching unit 1332, configured to match the prediction label with a reference label of the training data to obtain a prediction result, the reference label indicating a reference classification case of the training data;
a determination unit 1333, configured to determine at least one second decision tree model from the n first decision tree models based on the prediction results of the n first decision tree models for the training data respectively.

In an exemplary embodiment, the determination unit 1333 is configured to determine matching scores corresponding to the n first decision tree models respectively based on the prediction results of the n first decision tree models for the training data; and determine the at least one second decision tree model based on the matching scores corresponding to the n first decision tree models respectively.

In an exemplary embodiment, the determination unit 1333 is also configured to determine selection probabilities corresponding to the n first decision tree models respectively based on the matching scores, the selection probability indicating the probability that the first decision tree model is selected as the second decision tree model; the first decision tree model with the selection probability satisfying a preset probability condition is used as the second decision tree model.

In an exemplary embodiment, the prediction result includes a prediction success result or a prediction failure result.

The determination unit 1333 is also configured to perform bonus evaluation on the first decision tree model corresponding to the prediction success result in response to the prediction result being the prediction success result to obtain the matching score; or, in response to the prediction result being the prediction failure result, perform retention evaluation on the first decision tree model corresponding to the prediction success result to obtain the matching score.

In an exemplary embodiment, the feature determination module 1310 is configured to randomly select at least one data feature from the data features corresponding to the training data-set; or, select at least one data feature from the data features corresponding to the training data-set as the candidate feature based on an exponential mechanism.

FIG. 15 is a structural block diagram of a federated learning apparatus provided by another exemplary embodiment of the present disclosure. As shown in FIG. 15, the apparatus includes the following parts:
a receiving module 1510, configured to receive a second decision tree model transmitted by a first computing device, the first computing device being configured to determine at least one candidate feature from data features corresponding to a training data-set, and the candidate features corresponding to at least two decision trends in the decision tree model; obtain n first decision tree models by taking the at least one candidate feature as a model construction foundation, the value of n corresponding to the number of the candidate features; determine at least one second decision tree model from the n first decision tree models based on prediction results of the n first decision tree models on training data in the training data-set; and
a fusion module 1520, configured to fuse at least two decision tree models including the second decision tree model to obtain a federated learning model.

In an exemplary embodiment, the fusion module 1520 is configured to obtain a local decision tree model based on the data features corresponding to the local training data-set; and fuse the local decision tree model and the second decision tree model to obtain the federated learning model.

In an exemplary embodiment, the fusion module 1520 is also configured to determine the second decision tree model consistent with the features of the local decision tree model to obtain a decision tree model group; obtain an average classification value based on classification probabilities respectively corresponding to the decision tree models in the decision tree model group; and obtain the federated learning model based on a matching result of the average classification value and a preset classification threshold.

In an exemplary embodiment, the apparatus also includes:
a transmission module (not shown in the drawings), configured to analyze at least one piece of analysis data at the local terminal based on the federated learning model to obtain a data analysis result; or, transmit the federated learning model to the first computing device, the first computing device being configured to analyze the at least one piece of local analysis data based on the federated learning model to obtain the data analysis result.

It is to be noted that, the federated learning apparatus provided by the foregoing embodiments is illustrated only by taking the division of the above functional modules as an example. In the practical application, the above functions may be allocated to and completed by different functional modules according to requirements, that is, the internal structure of the device is divided into different functional modules, so as to complete all or some of the functions described above. In addition, the federated learning apparatus provided by the foregoing embodiments and the federated learning method embodiments fall within a same conception. For details of a specific implementation process, refer to the method embodiments. Details are not described herein again.

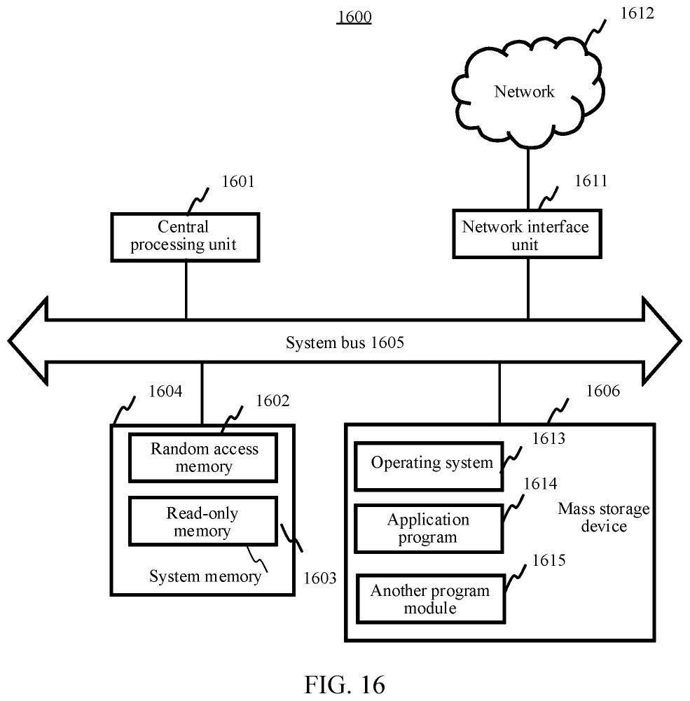

FIG. 16 is a schematic structural diagram of a server provided by an exemplary embodiment of the present disclosure. The server 1600 includes a central processing unit (CPU) 1601, a system memory 1604 including a random access memory (RAM) 1602 and a read-only memory (ROM) 1603, and a system bus 1605 connecting the system memory 1604 to the CPU 1601. The server 1600 also includes a mass storage device 1606 configured to store an operating system 1613, an application program 1614, and another program module 1615.

The mass storage device 1606 is connected to the CPU 1601 by using a mass storage controller (not shown) connected to the system bus 1605. The mass storage device 1606 and a computer-readable medium associated with the mass storage device 1606 provide non-volatile storage for the server 1600.

Generally, the computer-readable medium can include a computer storage medium and a communication medium. The system memory 1604 and the mass storage device 1606 can be collectively referred to as a memory.

According to various embodiments of the present disclosure, the server 1600 can be connected to a network 1612 through a network interface unit 1611 that is connected to the system bus 1605, or can also be connected to a network of another type or a remote computer system (not shown) through the network interface unit 1611.

The memory further includes one or more programs, which are stored in the memory and are configured to be executed by the CPU.

An embodiment of the present disclosure further provides a computer device, the computer device including a processor and a memory, the memory storing at least one instruction, at least one program, and a code set or an instruction set, and the at least one instruction, the at least one program, the code set or the instruction set being loaded and executed by the processor to implement the federated learning method provided by the foregoing method embodiments.

An embodiment of the present disclosure further provides a computer-readable storage medium, the computer-readable storage medium storing at least one instruction, at least one program, a code set, or an instruction set, the at least one instruction, the at least one program, the code set, or the instruction set being loaded and executed by a processor to implement the federated learning method provided by the foregoing method embodiments.

An embodiment of the present disclosure further provides a computer program product or a computer program, the computer program product or the computer program including a computer instruction, the computer instruction being stored in a computer-readable storage medium. A processor of the computer device reads the computer instruction from the computer-readable storage medium, and the processor executes the computer instruction to make the computer device execute any one of the above federated learning methods in the embodiments.

The term module (and other similar terms such as submodule, unit, subunit, etc.) in this disclosure may refer to a software module, a hardware module, or a combination thereof. Modules implemented by software are stored in memory or non-transitory computer-readable medium. The software modules, which include computer instructions or computer code, stored in the memory or medium can run on a processor or circuitry (e.g., ASIC, PLA, DSP, FPGA, or other integrated circuit) capable of executing computer instructions or computer code. A hardware module may be implemented using one or more processors or circuitry. A processor or circuitry can be used to implement one or more hardware modules. Each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

In some embodiments, the computer-readable storage medium may include: a read-only memory (ROM), a random access memory (RAM), a solid state drive (SSD), an optical disc, or the like. The RAM may include a resistance random access memory (ReRAM) and a dynamic random access memory (DRAM). The sequence numbers of the foregoing embodiments of the present disclosure are merely for description purpose but do not imply the preference among the embodiments.

What is claimed is:

1. A federated learning method, performed by a first computing device and comprising:
determining at least one candidate feature from data features corresponding to a training data-set, the candidate feature corresponding to at least two decision trends in a decision tree model;
obtaining n first decision tree models by taking the at least one candidate feature as a model construction foundation, value of n corresponding to number of the at least one candidate feature;
determining at least one second decision tree model from the n first decision tree models based on prediction results of the n first decision tree models on training data in the training data-set; and
transmitting the second decision tree model to a second computing device, the second computing device being configured to fuse at least two decision tree models that comprise the second decision tree model to obtain a federated learning model.

2. The method according to claim 1, wherein obtaining the n first decision tree models by taking the at least one candidate feature as the model construction foundation comprises:
generating at least two leaf nodes based on the candidate feature and the decision trends;
assigning values respectively to the at least two leaf nodes based on classification number of the decision tree models to obtain at least two leaf nodes marked with leaf node values; and
constructing the n first decision tree models based on the candidate feature, the decision trends and the at least two leaf nodes marked with the leaf node values.

3. The method according to claim 2, wherein the decision tree model comprises a binary classification model; and
assigning the values respectively to the at least two leaf nodes based on the classification number of the decision tree models to obtain the at least two leaf nodes marked with the leaf node values comprises:
assigning values to the at least two leaf nodes based on a binary classification standard of a binary classification model to obtain the at least two leaf nodes marked with the leaf node values, the binary classification standard indicating that the leaf node has two assignment cases.

4. The method according to claim 2, wherein generating the at least two leaf nodes based on the candidate feature and the decision trends comprises:
using a first candidate feature of the at least one candidate feature as a root node of the decision tree model, the first candidate feature being a feature of the at least one candidate feature; and
generating a leaf node having an association relationship with the root node based on the decision trends; or, determining an associated node having an association relationship with the root node based on the decision trends corresponding to the root node, the associated node indicating a second candidate feature, the second candidate feature being a feature of the candidate features other than the first candidate feature; and generating a leaf node having an association relationship with the associated node based on the decision trends corresponding to the associated node.

5. The method according to claim 2, wherein determining the at least one second decision tree model from the n first decision tree models based on the prediction results of the n first decision tree models on the training data in the training data-set comprises:
inputting the training data in the training data-set into the first decision tree model, and determining a prediction label corresponding to the training data;
matching the prediction label with a reference label of the training data to obtain a prediction result, the reference label indicating a reference classification case of the training data; and
determining the at least one second decision tree model from the n first decision tree models based on the corresponding prediction results of the n first decision tree models for the training data.

6. The method according to claim 5, wherein determining the at least one second decision tree model from the n first decision tree models based on the corresponding prediction results of the n first decision tree models for the training data comprises:
determining matching scores respectively corresponding to the n first decision tree models based on the corresponding prediction results of the n first decision tree models for the training data; and
determining the at least one second decision tree model based on the matching scores respectively corresponding to the n first decision tree models.

7. The method according to claim 6, wherein determining the at least one second decision tree model based on the matching scores respectively corresponding to the n first decision tree models comprises:
determining selection probabilities respectively corresponding to the n first decision tree models based on the matching scores, the selection probability indicating the probability that the first decision tree model is selected as the second decision tree model; and
using the first decision tree model with the selection probability satisfying a preset probability condition as the second decision tree model.

8. The method according to claim 6, wherein the prediction result comprises a prediction success result and a prediction failure result; and
determining the matching scores respectively corresponding to the n first decision tree models based on the corresponding prediction results of the n first decision tree models for the training data comprises:
performing bonus evaluation on the first decision tree model corresponding to the prediction success result in response to the prediction result being the prediction success result to obtain the matching score; or
performing retention evaluation on the first decision tree model corresponding to the prediction failure result in response to the prediction result being the prediction failure result to obtain the matching score.

9. The method according to claim 1, wherein determining the at least one candidate feature from the data features corresponding to the training data-set comprises:
randomly selecting at least one data feature from the data features corresponding to the training data-set as the candidate feature; or
selecting at least one data feature from the data features corresponding to the training data-set as the candidate feature based on an exponential mechanism.

10. A computer device, comprising a processor and a memory, the memory storing at least one instruction, at least one program, a code set or an instruction set, and the at least one instruction, the at least one program, the code set or the instruction set being loaded and executed by the processor to implement a federated learning method, the method comprising:
determining at least one candidate feature from data features corresponding to a training data-set, the candidate feature corresponding to at least two decision trends in a decision tree model;
obtaining n first decision tree models by taking the at least one candidate feature as a model construction foundation, value of n corresponding to number of the at least one candidate feature;
determining at least one second decision tree model from the n first decision tree models based on prediction results of the n first decision tree models on training data in the training data-set; and
transmitting the second decision tree model to a second computing device, the second computing device being configured to fuse at least two decision tree models that comprise the second decision tree model to obtain a federated learning model.

11. The device according to claim 10, wherein obtaining the n first decision tree models by taking the at least one candidate feature as the model construction foundation comprises:
generating at least two leaf nodes based on the candidate feature and the decision trends;
assigning values respectively to the at least two leaf nodes based on classification number of the decision tree models to obtain at least two leaf nodes marked with leaf node values; and
constructing the n first decision tree models based on the candidate feature, the decision trends and the at least two leaf nodes marked with the leaf node values.

12. The device according to claim 11, wherein the decision tree model comprises a binary classification model; and
assigning the values respectively to the at least two leaf nodes based on the classification number of the decision tree models to obtain the at least two leaf nodes marked with the leaf node values comprises:
assigning values to the at least two leaf nodes based on a binary classification standard of a binary classification model to obtain the at least two leaf nodes marked with the leaf node values, the binary classification standard indicating that the leaf node has two assignment cases.

13. The device according to claim 11, wherein generating the at least two leaf nodes based on the candidate feature and the decision trends comprises:
using a first candidate feature of the at least one candidate feature as a root node of the decision tree model, the first candidate feature being a feature of the at least one candidate feature; and
generating a leaf node having an association relationship with the root node based on the decision trends; or, determining an associated node having an association relationship with the root node based on the decision trends corresponding to the root node, the associated node indicating a second candidate feature, the second candidate feature being a feature of the candidate features other than the first candidate feature; and generating a leaf node having an association relationship with the associated node based on the decision trends corresponding to the associated node.

14. The device according to claim 11, wherein determining the at least one second decision tree model from the n first decision tree models based on the prediction results of the n first decision tree models on the training data in the training data-set comprises:
inputting the training data in the training data-set into the first decision tree model, and determining a prediction label corresponding to the training data;
matching the prediction label with a reference label of the training data to obtain a prediction result, the reference label indicating a reference classification case of the training data; and
determining the at least one second decision tree model from the n first decision tree models based on the corresponding prediction results of the n first decision tree models for the training data.

15. The device according to claim 14, wherein determining the at least one second decision tree model from the n first decision tree models based on the corresponding prediction results of the n first decision tree models for the training data comprises:
determining matching scores respectively corresponding to the n first decision tree models based on the corresponding prediction results of the n first decision tree models for the training data; and
determining the at least one second decision tree model based on the matching scores respectively corresponding to the n first decision tree models.

16. The device according to claim 15, wherein determining the at least one second decision tree model based on the matching scores respectively corresponding to the n first decision tree models comprises:
determining selection probabilities respectively corresponding to the n first decision tree models based on the matching scores, the selection probability indicating the probability that the first decision tree model is selected as the second decision tree model; and
using the first decision tree model with the selection probability satisfying a preset probability condition as the second decision tree model.

17. The device according to claim 15, wherein the prediction result comprises a prediction success result and a prediction failure result; and
determining the matching scores respectively corresponding to the n first decision tree models based on the corresponding prediction results of the n first decision tree models for the training data comprises:
performing bonus evaluation on the first decision tree model corresponding to the prediction success result in response to the prediction result being the prediction success result to obtain the matching score; or
performing retention evaluation on the first decision tree model corresponding to the prediction failure result in response to the prediction result being the prediction failure result to obtain the matching score.

18. The device according to claim 10, wherein determining the at least one candidate feature from the data features corresponding to the training data-set comprises:
randomly selecting at least one data feature from the data features corresponding to the training data-set as the candidate feature; or
selecting at least one data feature from the data features corresponding to the training data-set as the candidate feature based on an exponential mechanism.

19. A non-transitory computer-readable storage medium, storing at least one instruction, at least one program, a code set or an instruction set, and the at least one instruction, the at least one program, the code set or the instruction set being loaded and executed by a processor to implement a federated learning method, the method comprising:
determining at least one candidate feature from data features corresponding to a training data-set, the candidate feature corresponding to at least two decision trends in a decision tree model;
obtaining n first decision tree models by taking the at least one candidate feature as a model construction foundation, value of n corresponding to number of the at least one candidate feature;
determining at least one second decision tree model from the n first decision tree models based on prediction results of the n first decision tree models on training data in the training data-set; and
transmitting the second decision tree model to a second computing device, the second computing device being configured to fuse at least two decision tree models that comprise the second decision tree model to obtain a federated learning model.

20. The storage medium according to claim 19, wherein obtaining the n first decision tree models by taking the at least one candidate feature as the model construction foundation comprises:
generating at least two leaf nodes based on the candidate feature and the decision trends;
assigning values respectively to the at least two leaf nodes based on classification number of the decision tree models to obtain at least two leaf nodes marked with leaf node values; and
constructing the n first decision tree models based on the candidate feature, the decision trends and the at least two leaf nodes marked with the leaf node values.
